(19) United States
(12) Patent Application Publication
(10) Pub. No.: US 2023/0276472 A1
(43) Pub. Date: Aug. 31, 2023

(54) METHODS AND APPARATUS FOR USER EQUIPMENT SCHEDULING-BASED RESOURCE ALLOCATION

(71) Applicant: Lenovo (Beijing) Limited, Beijing (CN)

(72) Inventors: Jie HU, Beijing (CN); Jing HAN, Beijing (CN); Haiming WANG, Beijing (CN); Lianhai WU, Beijing (CN); Jie SHI, Beijing (CN); Ran YUE, Beijing (CN)

(21) Appl. No.: 18/005,767

(22) PCT Filed: Jul. 17, 2020
(86) PCT No.: PCT/CN2020/102715

§ 371 Date: Jan. 17, 2023

(51) Int. Cl. H04W 72/40; H04W 72/02; H04W 72/1263; H04W 72/543

(52) U.S. Cl. CPC H04W 72/40; H04W 72/02; H04W 72/543; H04W 72/1263

(57) ABSTRACT

Embodiments of the present disclosure relate to methods and apparatus for user equipment (UE) scheduling-based resource allocation. According to an embodiment of the present disclosure, a method performed by a first UE for wireless communication includes: broadcasting a scheduling indication comprising a serving range; receiving a scheduling request from a second UE within the serving range; and providing resource information to the second UE for performing sidelink transmission.

### TECHNICAL FIELD

Embodiments of the present disclosure are related to wireless communication technology, and more particularly, related to methods and apparatuses for user equipment (UE) scheduling-based resource allocation for sidelink communications.

### BACKGROUND

In a new radio (NR) communication system, a transmitting UE (hereinafter referred to as a “Tx UE”) may send a sidelink transmission to a specific receiving UE (hereinafter referred to as an “Rx UE”) in a unicast mode, to a group of Rx UEs in a groupcast mode, or to Rx UEs within a range in a broadcast mode.

For sidelink transmissions, there are two resource allocation modes specified since Long Term Evolution (LTE) Rel-12 Device-to-Device (D2D) communication and further extended to LTE/NR Vehicle-to-everything (V2X) communication: 1) mode 1: a base station (e.g., gNB or eNB) indicates sidelink resource(s) to a Tx UE for performing a sidelink transmission to an Rx UE; and 2) mode 2: a Tx UE autonomously selects sidelink resource(s) for performing a sidelink transmission from a resource pool (also referred to as a “mode 2 resource pool”) which contains sidelink resource(s) configured by a base station or pre-configured in standards. The resource allocation mode of a Tx UE can be configured by a base station or pre-configured in standards. A UE operating in mode 1 can be referred to as a “mode 1 UE,” and a UE operating in mode 2 can be referred to as a “mode 2 UE.”

When two mode 2 UEs with aperiodic traffic try to allocate similar resources simultaneously, since the selection window from which each UE selects sidelink resource(s) is short to meet the latency requirement of the aperiodic traffic, it is possible that the two UEs may select the same resource, which results in a Tx resource conflict. Moreover, a UE cannot easily predict its Rx timing when handing an aperiodic traffic, and a half-duplex problem may happen, that is, a message may be transmitted to the UE when the UE is transmitting another message. There is a need to coordinate resource allocation or selection among UEs to avoid the Tx resource conflict and minimize the half-duplex problem, especially for services with stringent quality of service (QoS) requirements.

### SUMMARY OF THE DISCLOSURE

The present disclosure provides a centralized scheduling scheme to coordinate resource allocation or selection among UEs, for example, by a scheduling UE (hereinafter referred to as an “S-UE”), which may achieve more reliable performance than the legacy mechanism.

According to an embodiment of the present disclosure, a method performed by a first UE for wireless communication may include: broadcasting a scheduling indication comprising a serving range; receiving a scheduling request from a second UE within the serving range; and providing resource information to the second UE for performing sidelink transmission.

According to another embodiment of the present disclosure, a method performed by a first UE for wireless communication may include: receiving a scheduling indication comprising a serving range of a second UE; transmitting a scheduling request to the second UE when the first UE is within the serving range of the second UE; and receiving resource information from the second UE for performing sidelink transmission.

According to still another embodiment of the present disclosure, an apparatus may include: at least one non-transitory computer-readable medium having stored thereon computer executable instructions; at least one receiving circuitry; at least one transmitting circuitry; and at least one processor coupled to the at least one non-transitory computer-readable medium, the at least one receiving circuitry and the at least one transmitting circuitry. The computer executable instructions may cause the at least processor to implement a method according to any embodiment of the present disclosure.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the present disclosure can be obtained, a description of the present disclosure is rendered by reference to specific embodiments thereof which are illustrated in the appended drawings. These drawings depict only exemplary embodiments of the present disclosure and are not therefore intended to limit the scope of the present disclosure.

FIG. 1 illustrates a schematic diagram of a wireless communication system according to some embodiments of the present application;

FIG. 2 illustrates a timeline of an exemplary sensing and resource selecting procedure according to some embodiments of the present disclosure;

FIGS. 3A-3C illustrate examples of S-UEs according to some embodiments of the present disclosure;

FIG. 4 illustrates a flow chart of an exemplary procedure for UE scheduling-based resource allocation according to some embodiments of the present disclosure;

FIG. 5 illustrates an exemplary block diagram of an apparatus according to some embodiments of the present disclosure; and

FIG. 6 illustrates an exemplary block diagram of another apparatus according to some embodiments of the present disclosure.

### DETAILED DESCRIPTION

The detailed description of the appended drawings is intended as a description of the currently preferred embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

In the following description, numerous specific details are provided, such as examples of programming, software modules, network transactions, database structures, hardware modules, hardware circuits, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference will now be made in detail to some embodiments of the present disclosure, examples of which are illustrated in the accompanying drawings. To facilitate understanding, embodiments are provided under specific network architecture and new service scenarios, such as 3rd Generation Partnership Project (3GPP) 5G, 3GPP LTE and so on. Persons skilled in the art know very well that, with the development of network architecture and new service scenarios, the embodiments in the present disclosure are also applicable to similar technical problems; and moreover, the terminologies recited in the present disclosure may change, which should not affect the principle of the present disclosure.

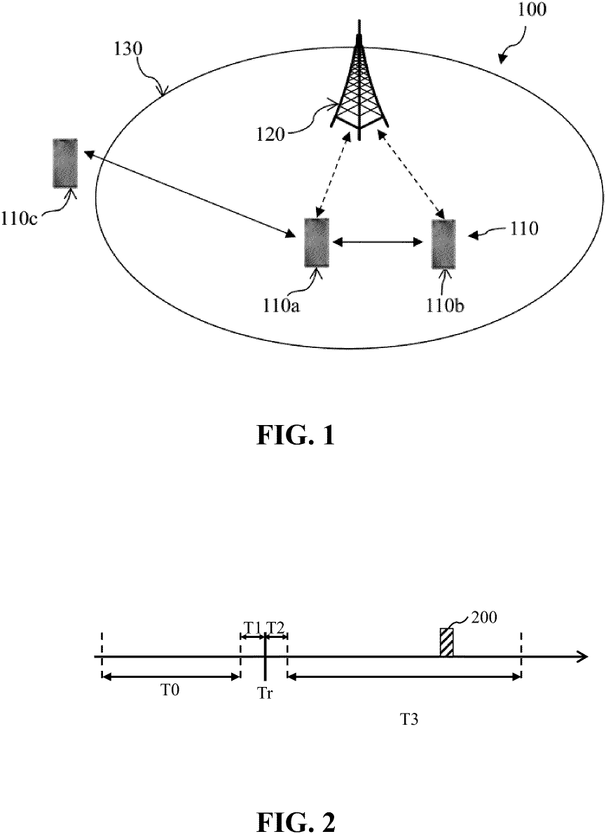

FIG. 1 illustrates a schematic diagram of a wireless communication system 100 according to some embodiments of the present application.

As shown in FIG. 1, a wireless communication system 100 may include a base station (BS), e.g., BS 120, and some UEs, e.g., UE 110a, UE 110b, and UE 110c (collectively referred to as UEs 110). Although a specific number of UEs 110 and one BS 120 are depicted in FIG. 1, it is contemplated that wireless communication system 100 may also include more BSs and more or fewer UEs in and outside of the coverage of the BSs.

The UEs and the BS may support communication based on, for example, 3G, LTE, LTE-advanced (LTE-A), NR, or other suitable protocol(s). For example, the BS 120 may include an eNB or a gNB. The UE 110a, UE 110b, or UE 110c may include, for example, but is not limited to, a computing device, a wearable device, a mobile device, an IoT (Internet of Things) device, a vehicle, etc. Persons skilled in the art should understand that as technology develops and advances, the terminologies described in the present disclosure may change, but should not affect or limit the principles and spirit of the present disclosure.

The BS 120 may define one or more cells, and each cell may have a coverage area 130. In the exemplary wireless communication system 100, some UEs (e.g., UE 110a and UE 110b) are within the coverage of the BS 120, which may not be a specific BS 120 shown in FIG. 1 and can be any one of the BSs 120 in a wireless communication system, and some UEs (e.g., UE 110c) are outside of the coverage of the BS 120. For example, in the case that the wireless communication system includes two BSs 120, UE 110a being within the coverage of any one of the two BSs 120 means that UE 110a is within the coverage of a BS 120 (i.e., in-coverage) in the wireless communication system; and UE 110a being outside of the coverage of both BSs 120 means that UE 110a is outside of the coverage of a BS 120 (i.e., out-of-coverage) in the wireless communication system.

Still referring to FIG. 1, the UE 110a and UE 110b may communicate with the BS 120 via, for example, a Uu link (denoted by dotted arrow in FIG. 1). The UE 110a, UE 110b, and UE 110c may communicate with each other (e.g., UE 110a may communicate with UE 110b, or UE 110a may communicate with UE 110c) via a sidelink (denoted by solid arrow in FIG. 1), and may form a UE group. During a sidelink communication, a Tx UE may transmit signaling, data, or both to an Rx UE. For example, referring to FIG. 1, a Tx UE (e.g., UE 110a) may transmit data to an Rx UE (e.g., UE 110b or UE 110c).

As described above, there are two resource allocation modes for sidelink transmissions. In mode 1, sidelink resource(s) is(are) assigned by a network (e.g., by a base station), for example, via dynamic scheduling or configured grant. In mode 2, sidelink resource(s) is(are) selected from a configured or pre-configured resource pool by a Tx UE itself. Either for mode 1 or for mode 2, after sidelink resource(s) to be used or reserved is(are) determined, the UE may transmit sidelink control information (SCI) on a physical sidelink control channel (PSCCH) which indicates the time-frequency resources in which the UE transmits a physical sidelink shared channel (PSSCH). These SCI transmissions are used by sensing UEs to maintain a record of which resources have been used or reserved by others UEs in the recent past, such that the surrounding UE(s) can avoid using the sidelink resource(s) indicated by the SCI (which the surrounding UE(s) may deem unavailable resource(s)) to avoid collision or interference.

A Tx UE operating in mode 2 normally performs a sensing and resource selecting procedure before performing a sidelink transmission to an Rx UE. FIG. 2 illustrates a timeline of an exemplary sensing and resource selecting procedure according to some embodiments of the present disclosure.

As shown in FIG. 2, when a resource selection for a mode 2 UE is triggered (e.g., by traffic arrival or a re-selection trigger), the mode 2 UE may consider a sensing window T0 which starts a configured or preconfigured time in the past and finishes shortly (e.g., a first processing period T1) before the trigger time Tr. The mode 2 UE may process the sensing result(s) obtained in the sensing window in the first processing period T1. The sensing window can be either 1100 ms or 100 ms wide, with the intention that the 100 ms option is particularly for aperiodic traffic, and the 1100 ms option is particularly for periodic traffic.

Next, the mode 2 UE may select resource(s) for its transmission(s) or retransmission(s) from within a resource selection window T3. The selection window T3 starts shortly (e.g., a second processing period T2) after the trigger time Tr and cannot be longer than the remaining latency budget of the packet to be transmitted. In the second processing period T2, the mode 2 UE may perform any necessary processing that should be performed before a sidelink transmission, including determining a length of the selection window T3. The mode 2 UE may autonomously select time-frequency resource(s) within the selection window T3 and perform a sidelink transmission using the selected resource(s), e.g., resource 200. It should be understood that the durations of T0, T1, T2, and T3 are provided only for illustrative purposes, and should not be construed as limits to the embodiments of the present disclosure.

Due to randomness of the occurrence of aperiodic traffic, two different UEs with aperiodic traffic may have to select sidelink resource(s) within the same selection window. When the traffic requires tight latency, the selection window T3 is short and it is difficult for the two UEs to select different sidelink sources. Then, a Tx resource conflict may happen. Furthermore, a UE cannot easily predict its Rx timing when handing an aperiodic traffic, and a half-duplex problem may happen.

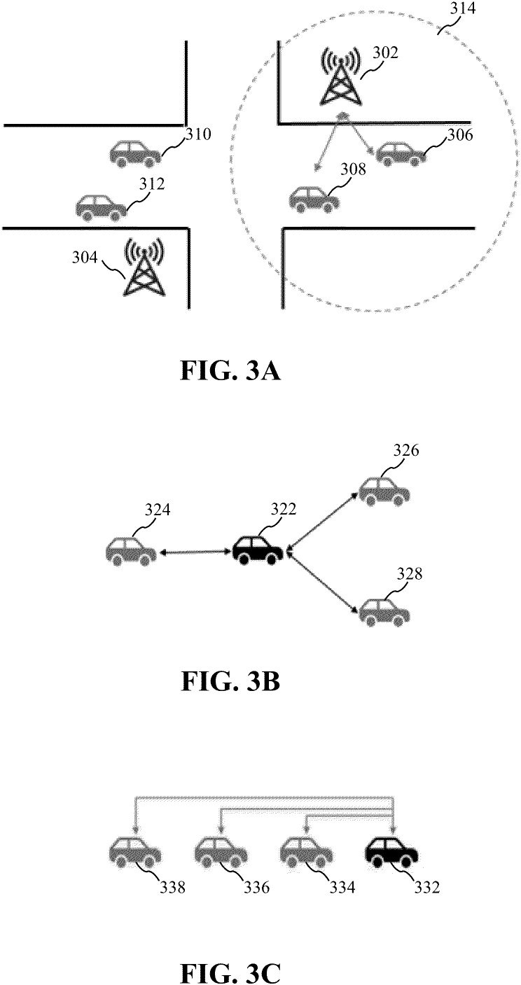

A scheduling UE (S-UE) can be used to perform a centralized scheduling for resource allocation or selection of UEs within a serving range of the S-UE to avoid the above problems. The S-UE may include but is not limited to a road side unit (RSU), a relay UE, or a group leader. FIGS. 3A-3C illustrate examples of S-UEs according to some embodiments of the present disclosure. In FIGS. 3A-3C, mode 2 UEs are shown as vehicles. It should be understood that mode 2 UEs may be other devices such as a computing device, a wearable device, a mobile device, or an IoT device. It should also be understood that the numbers of S-UEs and mode 2 UEs are provided only for illustrative purposes, and should not be construed as limits to the embodiments of the present disclosure.

FIG. 3A illustrates a scenario where an RSU 302 is configured as an S-UE. FIG. 3A shows RSUs 302, 304, and mode 2 UEs 306, 308, 310, 312, wherein UEs 306 and 308 are passing nearby RSU 302 and can communicate with RSU 302. Thus, UEs 306 and 308 are within the serving range 314 of RSU 302 as an S-UE, and RSU 302 may coordinate the resource allocation for UEs 306 and 308. In other words, RSU 302 may serve UEs 306 and 308.

FIG. 3B illustrates a scenario where a relay UE 322 is configured as an S-UE. FIG. 3B shows a relay UE 322 and mode 2 UEs 324, 326, 328. The relay UE 322 may relay communications received from UE 324 to UE 326 and/or UE 328, or vice versa. As an S-UE, the relay UE 322 may coordinate the resource allocation for UEs 324, 326, and 328. In other words, the relay UE 322 may serve UEs 324, 326, and 328.

FIG. 3C illustrates a scenario where a group leader is configured as an S-UE. FIG. 3C shows a UE group including UEs 332, 334, 336, 338, wherein UE 332 is a group leader. As an S-UE, the UE 332 may coordinate the resource allocation for UEs 334, 336, and 338. In other words, the UE 332 may serve UEs 334, 336, and 338.

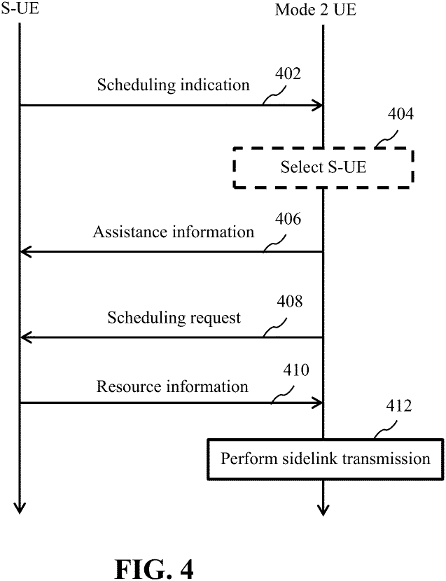

FIG. 4 illustrates a flow chart of an exemplary procedure for UE scheduling-based resource allocation according to some embodiments of the present disclosure.

In step 402, an S-UE (e.g., any S-UE illustrated in FIGS. 3A-3C) may broadcast a scheduling indication. Although FIG. 4 shows that the S-UE transmits the scheduling indication to one mode 2 UE, it is contemplated that the scheduling indication may be broadcast to one or more mode 2 UEs. According to some embodiments of the present disclosure, the scheduling indication may include a serving range of the S-UE.

The serving range may be associated with one of the followings: a zone configuration, a validity area configuration, a UE group, a resource pool configuration, or a distance range centered on the S-UE. For example, when the serving range of the S-UE is associated with a zone configuration (e.g., at least one zone identifier (ID)), the S-UE may serve mode 2 UEs within the specific zone(s) identified by the at least one zone ID. As another example, a validity area is defined that a mode 2 UE does not need to acquire a new mode 2 resource configuration while moving in the validity area. When the serving range of the S-UE is associated with a validity area configuration (e.g., a validity area ID such as SystemInformationAreaID), the S-UE may serve mode 2 UEs within the specific validity area identified by the validity area ID. When the serving range of the S-UE is associated with a UE group (e.g., a group ID), the S-UE may serve mode 2 UEs within the specific UE group identified by the group ID. When the serving range of the S-UE is associated with a resource pool configuration (e.g., at least one pool ID), the S-UE may serve mode 2 UEs configured or preconfigured with the specific resource pool(s) identified by the at least one pool ID. When the serving range of the S-UE is associated with a specific distance range centered on the S-UE, the S-UE may serve mode 2 UEs within the specific distance range. It is contemplated that the serving range can be defined in other forms without departing from the spirit and scope of the disclosure.

According to some embodiments of the present disclosure, the scheduling indication may further include one or more of: a UE identifier, geographical information, and resource pool information.

The UE identifier is used to identify the S-UE and may be preconfigured or configured or determined by an upper layer. For example, when an RSU (e.g., RSU 302) is configured as an S-UE, the UE identifier can be an RSU identifier; when a relay UE (e.g., relay UE 322) is configured as an S-UE, the UE identifier can be a relay UE identifier; when a group leader (e.g., UE 332) is configured as an S-UE, the UE identifier can be a group leader identifier.

The geographical information may indicate a geographical location of the SUE. The resource pool information may include at least one resource configured or preconfigured to be scheduled by the S-UE. The resource pool information may indicate a dedicated scheduling resource subset, dedicated scheduling resource pool, or mode 2 resource pool. The dedicated scheduling resource subset or dedicated scheduling resource pool may be configured by dedicated higher layer signaling (e.g., radio resource control (RRC) signaling or system information block (SIB) signaling) or preconfigured.

Although FIG. 4 shows that the mode 2 UE receives the scheduling indication from one S-UE, it is contemplated that the mode 2 UE may receive scheduling indication(s) from one or more S-UEs. When the mode 2 UE is within an overlapping area of the serving ranges indicated by the scheduling indications received from multiple S-UEs (i.e., the mode 2 UE is within the serving range of each of the multiple S-UEs), the mode 2 UE may select a unique S-UE from the multiple S-UEs to serve the mode 2 UE (step 404). For example, the mode 2 UE may select the unique S-UE based on a reference signal received power (RSRP) value associated with each S-UE. It is contemplated that the unique S-UE can be selected based on other measurements or characteristics without departing from the spirit and scope of the disclosure. When the mode 2 UE is within the serving range of only one S-UE, the S-UE serves as the unique S-UE, and the selecting step (i.e., step 404) can be omitted. So step 404 is shown as a dashed block in FIG. 2. In step 406, the mode 2 UE may transmit assistance information to the S-UE, which is the unique S-UE, when the mode 2 UE is within the serving range of the S-UE.

In an embodiment of the present disclosure, the assistance information may be transmitted during establishment of an RRC connection between the mode 2 UE and the S-UE, e.g., via RRCReconfigurationsidelink. In another embodiment of the present disclosure, the assistance information may be transmitted after establishment of the RRC connection between the mode 2 UE and the S-UE, e.g., via a dedicated RRC message. In another embodiment of the present disclosure, the S-UE may configure the mode 2 UE within its serving range to periodically report the assistance information, e.g., via the existing measurement report signaling. In another embodiment of the present disclosure, the S-UE may configure the mode 2 UE within its serving range to report the assistance information in a one-shot message based on the S-UE’s indication.

The assistance information may include any information associated with the mode 2 UE that the S-UE may take into account when making its resource scheduling decision for the UEs within the serving range of the S-UE. The S-UE may store the assistance information from the mode 2 UE for later use. According to some embodiments of the present disclosure, the assistance information may include but is not limited to at least one of: a sensing result, geographical information, velocity information, channel state information, or other measurement(s) of the mode 2 UE. The mode 2 UE may obtain the sensing result by performing a sensing step as described above with respect to FIG. 2. The geographical information coordinating with the velocity information may assist the S-UE to estimate when the mode 2 UE will leave the serving range of the S-UE.

When the mode 2 UE has a traffic arrival or resource reselection is triggered and is within the serving range of the S-UE, which is the unique S-UE, the mode 2 UE may transmit a scheduling request to the S-UE (step 408). The mode 2 UE may perform a sensing and resource selecting procedure as described above with respect to FIG. 2 in a mode 2 resource pool configured or preconfigured for the mode 2 UE to transmit the scheduling request. According to some embodiments of the present disclosure, the mode 2 UE may transmit the scheduling request to the S-UE when the incoming traffic has a stringent QoS requirement, while performing resource selection using a legacy procedure (e.g., the sensing and resource selecting procedure illustrated in FIG. 2) when the QoS requirement of the incoming traffic is not stringent. For example, the mode 2 UE may transmit the scheduling request to the S-UE when a QoS parameter (e.g. reliability, packet delay budget, etc.) of the incoming traffic is within a specified range (e.g., the QoS parameter reaches a specified threshold). As another example, the mode 2 UE may transmit the scheduling request to the S-UE when available resource(s) sensed by the mode 2 UE cannot meet the QoS requirement of the incoming traffic. It is contemplated that the mode 2 UE can trigger the transmission of the scheduling request under other conditions according to its own implementation, without departing from the spirit and scope of the disclosure.

According to some embodiments of the present disclosure, the scheduling request may include but is not limited to one or more of: at least one QoS parameter, at least one traffic characteristic, or a sidelink buffer status report for the incoming traffic. For example, the traffic characteristic parameters may include but is not limited to at least one of: a preferred semi-persistent scheduling (SPS) interval, timing offset with respect to subframe 0 of the SFN 0, ProSe Per-Packet Priority (PPPP), ProSe Per-Packet Reliability (PPPR), Destination Layer-2 ID, and maximum transport block (TB) size based on observed traffic pattern, related to SPS or non-SPS configuration. The sidelink buffer status report is associated with the data buffered in the mode 2 UE for a group of logical channels per destination. In an embodiment of the present disclosure, the scheduling request may indicate a preferred resource of the mode 2 UE for performing sidelink transmission.

After receiving the scheduling request, the S-UE may provide resource information to the mode 2 UE for performing sidelink transmission based on the scheduling request (step 410). In an embodiment of the present disclosure, the resource information may indicate an individual resource (e.g., a resource index) from a dedicated scheduling resource subset or dedicated scheduling resource pool of the SUE. The dedicated scheduling resource subset or dedicated scheduling resource pool may be configured by dedicated higher layer signaling (e.g., RRC signaling or SIB signaling) or preconfigured. In another embodiment of the present disclosure, the resource information may indicate available resource information from a mode 2 resource pool. For example, the available resource information may be an individual resource (e.g., a resource index) or available resource subset(s) from the mode 2 resource pool. In the case where the scheduling request from the mode 2 UE indicates a preferred resource of the mode 2 UE for performing sidelink transmission, the resource information provided by the S-UE in response to the scheduling request may include a command overwriting or confirming the preferred resource indicated in the scheduling request.

After receiving the resource information scheduled and provided by the S-UE, the mode 2 UE may perform sidelink transmission based on the resource information (step 412). For example, when the resource information indicates an individual resource from the dedicated scheduling resource subset, dedicated scheduling resource pool, or the mode 2 resource pool, the mode 2 UE may perform the sidelink transmission using the individual resource indicated by the resource information from the S-UE. When the resource information indicates available resource subset(s) from the mode 2 resource pool, the mode 2 UE may randomly select a resource from the available resource subset(s) and perform the sidelink transmission using the selected resource. When the resource information includes a command overwriting or confirming the preferred resource indicated in the scheduling request, the mode 2 UE may perform the sidelink transmission using the resource indicated by the command from the S-UE.

According to some embodiments of the present disclosure, when an access stratum (AS) configuration failure or a radio link failure occurs between the mode 2 UE and the S-UE (i.e., the unique S-UE for the mode 2 UE), the mode 2 UE cannot transmit the scheduling request to the S-UE or cannot receive the resource information from the S-UE. In such cases, the mode 2 UE may perform a sensing and resource selecting procedure (e.g., the procedure illustrated in FIG. 2) to select a resource from a configured or preconfigured mode 2 resource pool to perform the sidelink transmission.

According to some embodiments of the present disclosure, when no resource information is received from the S-UE within a specified time window after transmission of the scheduling request, the mode 2 UE may perform a sensing and resource selecting procedure (e.g., the procedure illustrated in FIG. 2) to select a resource from a configured or preconfigured mode 2 resource pool to perform the sidelink transmission.

According to some embodiments of the present disclosure, when the mode 2 UE leaves the serving range of the S-UE (i.e., the mode 2 UE cannot be served by the S-UE), the mode 2 UE may perform a sensing and resource selecting procedure (e.g., the procedure illustrated in FIG. 2) to select a resource from a configured or preconfigured mode 2 resource pool to perform the sidelink transmission.

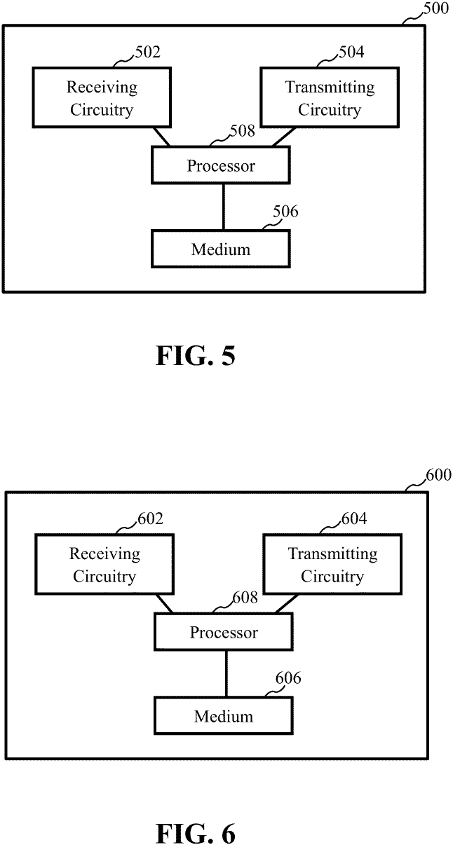

FIG. 5 illustrates an exemplary block diagram of an apparatus 500 according to some embodiments of the present disclosure. In some embodiments of the present disclosure, the apparatus 500 may be an S-UE or other devices having similar functionalities, which can at least perform the method illustrated in FIG. 4.

As shown in FIG. 5, the apparatus 500 may include at least one receiving circuitry 502, at least one transmitting circuitry 504, at least one non-transitory computer-readable medium 506, and at least one processor 508 coupled to the at least one receiving circuitry 502, the at least one transmitting circuitry 504, the at least one non-transitory computer-readable medium 506.

Although in FIG. 5, elements such as receiving circuitry 502, transmitting circuitry 504, non-transitory computer-readable medium 506, and processor 508 are described in the singular, the plural is contemplated unless limitation to the singular is explicitly stated. In some embodiments of the present disclosure, the at least one receiving circuitry 502 and the at least one transmitting circuitry 504 are combined into a single device, such as a transceiver. In certain embodiments of the present disclosure, the apparatus 500 may further include an input device, a memory, and/or other components.

In some embodiments of the present disclosure, the at least one non-transitory computer-readable medium 506 may have stored thereon computer-executable instructions which are programmed to cause the at least one processor 508 to implement the steps of the methods, for example as described in view of FIG. 4, with the at least one receiving circuitry 502 and the at least one transmitting circuitry 504. For example, when executed, the instructions may cause the at least one processor 508 to broadcast a scheduling indication including a serving range with the at least one transmitting circuitry 504. The instructions may further cause the at least one processor 508 to receive, with the at least one receiving circuitry 502, a scheduling request from a second UE (e.g., a mode 2 UE) within the serving range. The instructions may further cause the at least one processor 508 to provide, with the at least one transmitting circuitry 504, resource information to the second UE for performing sidelink transmission. In some embodiments of the present disclosure, the instructions may further cause the at least one processor 508 to receive assistance information from the second UE within the serving range with the at least one receiving circuitry 502.

FIG. 6 illustrates an exemplary block diagram of an apparatus 600 according to some embodiments of the present disclosure. In some embodiments of the present disclosure, the apparatus 600 may be a mode 2 UE or other devices having similar functionalities, which can at least perform the method illustrated in FIG. 4.

As shown in FIG. 6, the apparatus 600 may include at least one receiving circuitry 602, at least one transmitting circuitry 604, at least one non-transitory computer-readable medium 606, and at least one processor 608 coupled to the at least one receiving circuitry 602, the at least one transmitting circuitry 604, the at least one non-transitory computer-readable medium 606.

Although in FIG. 6, elements such as receiving circuitry 602, transmitting circuitry 604, non-transitory computer-readable medium 606, and processor 608 are described in the singular, the plural is contemplated unless limitation to the singular is explicitly stated. In some embodiments of the present disclosure, the at least one receiving circuitry 602 and the at least one transmitting circuitry 604 are combined into a single device, such as a transceiver. In certain embodiments of the present disclosure, the apparatus 600 may further include an input device, a memory, and/or other components.

In some embodiments of the present disclosure, the at least one non-transitory computer-readable medium 606 may have stored thereon computer-executable instructions which are programmed to cause the at least one processor 608 to implement the steps of the methods, for example as described in view of FIG. 4, with the at least one receiving circuitry 602 and the at least one transmitting circuitry 604. For example, when executed, the instructions may cause the at least one processor 608 to receive a scheduling indication including a serving range of a second UE (e.g., an SUE) with the at least one receiving circuitry 602. The instructions may further cause the at least one processor 608 to transmit, with the at least one transmitting circuitry 604, a scheduling request to the second UE when the apparatus 600 is within the serving range of the second UE. The instructions may further cause the at least one processor 608 to receive, with the at least one receiving circuitry 602, resource information from the second UE for performing sidelink transmission. In some embodiments of the present disclosure, the instructions may further cause the at least one processor 608 to transmit, with the at least one transmitting circuitry 604, assistance information to the second UE when the apparatus 600 is within the serving range of the second UE. In some embodiments of the present disclosure, the instructions may further cause the at least one processor 608 to select, from one or more UEs, the second UE as a unique SUE serving the apparatus 600 when the apparatus 600 is within a serving range of each of the one or more UEs.

As will be appreciated by one skilled in the art, aspects of the embodiments may be embodied as a system, apparatus, method, or a program product. Accordingly, embodiments may take the form of an all-hardware embodiment, an all-software embodiment (including firmware, resident software, micro-code, etc.) or an embodiment combining software and hardware aspects.

For example, the disclosed embodiments may be implemented as a hardware circuit comprising custom very-large-scale integration (VLSI) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, or program code. The storage devices may be tangible, non-transitory, or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but is not limited to being, an electronic, magnetic, optical, electromagnetic, infrared, holographic, micromechanical, or semiconductor system, apparatus, or device, or any suitable combination of the foregoing.

A non-exhaustive list of more specific examples of the storage device may include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Furthermore, the described features, structures, or characteristics of the embodiments may be combined in any suitable manner. While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1-44. (canceled)

45. A first user equipment (UE), comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to implement a method, the method comprising:
broadcasting a scheduling indication comprising a serving range;
receiving a scheduling request from a second UE within the serving range; and
providing resource information to the second UE for performing sidelink transmission.

46. The first UE of claim 45, wherein the scheduling indication further comprises one or more of: a UE identifier, geographical information, or resource pool information.

47. The first UE of claim 45, wherein the serving range is associated with one of a zone configuration, a validity area configuration, a UE group, a resource pool configuration, or a distance range centered on the first UE.

48. The first UE of claim 45, wherein the scheduling request comprises one or more of: at least one quality of service (QoS) parameter, at least one traffic characteristic, or a sidelink buffer status report for an incoming traffic of the second UE.

49. The first UE of claim 45, wherein the resource information indicates an individual resource from a dedicated scheduling resource subset or dedicated scheduling resource pool of the first UE.

50. The first UE of claim 45, wherein the resource information indicates an individual resource from a mode 2 resource pool or an available resource subset from a mode 2 resource pool.

51. The first UE of claim 45, wherein the scheduling request indicates a preferred resource of the second UE for performing sidelink transmission.

52. The first UE of claim 45, further comprising receiving assistance information from the second UE within the serving range.

53. A method performed by a first user equipment (UE) for wireless communication, the method comprising:
broadcasting a scheduling indication comprising a serving range;
receiving a scheduling request from a second UE within the serving range; and
providing resource information to the second UE for performing sidelink transmission.

54. A first user equipment (UE), comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to implement a method,, the method comprising:
receiving a scheduling indication comprising a serving range of a second UE;
transmitting a scheduling request to the second UE when the first UE is within the serving range of the second UE; and
receiving resource information from the second UE for performing sidelink transmission.

55. The first UE of claim 54, wherein the scheduling indication further comprises one or more of: an UE identifier, geographical information, or resource pool information.

56. The first UE of claim 54, wherein the serving range is associated with one of a zone configuration, a validity area configuration, a UE group, a resource pool configuration, or a distance range centered on the second UE.

57. The first UE of claim 54, wherein the scheduling request comprises one or more of: at least one quality of service (QoS) parameter, at least one traffic characteristic, or a sidelink buffer status report for an incoming traffic of the first UE.

58. The first UE of claim 54, wherein the scheduling request is transmitted when a quality of service (QoS) parameter for an incoming traffic of the first UE is within a specified range or when an available resource sensed by the first UE cannot meet a QoS requirement for an incoming traffic of the first UE.

59. The first UE of claim 54, wherein the scheduling request indicates a preferred resource of the first UE for performing sidelink transmission.

60. The first UE of claim 54, further comprising transmitting assistance information to the second UE when the first UE is within the serving range of the second UE.

61. The first UE of claim 54, further comprising:
selecting, from one or more UEs, the second UE as a unique scheduling UE serving the first UE when the first UE is within a serving range of each of the one or more UEs.

62. The first UE of claim 54, further comprising:
performing a sensing and resource selecting procedure when an access stratum (AS) configuration failure or a radio link failure occurs between the first UE and the second UE.

63. The first UE of claim 54, further comprising:
transmitting a second scheduling request to the second UE when the first UE is within the serving range of the second UE; and
performing a sensing and resource selecting procedure when no resource information is received from the second UE within a specified time window after transmission of the second scheduling request.

64. The first UE of claim 54, further comprising:
performing a sensing and resource selecting procedure when the first UE leaves the serving range of the second UE.
